(19) United States
(12) Patent Application Publication
(10) Pub. No.: US 2015/0277606 A1
(43) Pub. Date: Oct. 1, 2015

(54) TOUCH UNIT AND TOUCH DISPLAY APPARATUS

(71) Applicant: Samsung Display Co., LTD., Yongin-City (KR)

(72) Inventor: Chul KIM, Hwaseong-si, Gyeonggi-do (KR)

(21) Appl. No.: 14/630,521

(22) Filed: Feb. 24, 2015

(30) Foreign Application Priority Data
Apr. 1, 2014 (KR) 10-2014-0038816

(51) Int. Cl. G06F 3/041

(52) U.S. Cl. CPC G06F 3/041

(57) ABSTRACT

A touch unit includes a touch panel and a touch panel driver. The touch panel includes an active region in which a touch event is sensed and a peripheral region surrounding the active region. The touch panel driver includes a plurality of touch driving chips disposed in the peripheral region and a flexible printed circuit board connecting the touch driving chip to a host.

### CROSS-REFERENCE TO RELATED APPLICATION

This application claims priority under 35 U.S.C. §119 to Korean Patent Application No. 10-2014-0038816, filed on Apr. 1, 2014 in the Korean Intellectual Property Office KIPO; the contents of the Korean application are incorporated herein by reference.

### BACKGROUND

1. Field

The present invention may be related to a touch unit and a touch display apparatus that includes the touch unit. The touch unit may have a substantially simple module structure.

2. Description of the Related Art

A display apparatus may include a touch panel. The touch panel may be integrated with a display panel of the display apparatus and may enable the display apparatus to be controlled by a touch inputted by a touch providing means, such as a stylus pen or a finger. Advantageously, an additional separate input device, such as a remote controller, may not be required.

The touch panel may represent, for example, a capacitive type touch panel, a resistive type touch panel, or an optical type touch panel. In general, a module structure of the touch panel and/or a related touch panel driver may be substantially complicated. Therefore, manufacturing costs of the touch panel and/or the display apparatus may be undesirably high.

### SUMMARY OF THE INVENTION

Embodiments of the present invention provide a touch unit simplifying a module structure of a touch panel and a touch panel driver and reducing a manufacturing cost.

Embodiments of the present invention also provide a touch display apparatus including the touch unit.

The touch unit includes a touch panel and a touch panel driver. The touch panel includes an active region in which a touch event is sensed and a peripheral region surrounding the active region. The touch panel driver includes a plurality of touch driving chips disposed in the peripheral region and a flexible printed circuit board electrically connecting the touch driving chip to a host.

The touch driving chip may be mounted on the peripheral region of the touch panel.

The touch driving chip may be mounted on the peripheral region of the touch panel in a chip-on-glass structure.

The touch panel may include a plurality of touch electrodes configured to sense the touch event and a plurality of signal lines electrically connecting the touch electrodes and the touch driving chip.

The touch panel may further include a transmitting line electrically connecting between the touch driving chips.

The signal line and the transmitting line may be simultaneously formed.

The signal line and the transmitting line may include substantially the same material.

The touch driving chips may communicate with each other through the transmitting line in a serial peripheral interface (“SPI”) method or an inter-integrated circuit (“I2C”) method.

The touch electrodes may include a plurality of transceiver (TX) electrodes and a plurality of receiver (RX) electrodes. The signal lines may include a plurality of driving lines electrically connecting the TX electrodes to the touch driving chip and a plurality of sensing lines electrically connecting the RX electrodes to the touch driving chip.

The touch panel may further include a first bridge electrically connecting the adjacent RX electrodes and a second bridge electrically connecting the adjacent TX electrodes.

The touch panel may further include an insulating layer disposed between the first bridge and the second bridge.

The second bridge, the RX electrode and the TX electrode may be simultaneously formed.

The touch driving chips may be disposed along a first side of the touch panel. The flexible printed circuit board may extend from the first side of the touch panel to out of the touch panel.

The touch driving chips may be disposed along a first side and a second side of the touch panel. The touch panel driver may include a first flexible printed circuit board extending from the first side of the touch panel to out of the touch panel and a second flexible printed circuit board extending from the second side of the touch panel to out of the touch panel.

The touch driving chips may be disposed along a first side and a second side of the touch panel. The flexible printed circuit board may extend from the first side of the touch panel to out of the touch panel.

In an exemplary embodiment of a touch display apparatus according to the present invention, the touch display apparatus includes a touch unit and a display panel. The touch unit includes a touch panel and a touch panel driver. The touch panel includes an active region in which a touch event is sensed and a peripheral region surrounding the active region. The touch panel driver includes a plurality of touch driving chips disposed in the peripheral region and a flexible printed circuit board electrically connecting the touch driving chip to a host. The display panel is disposed under the touch panel and configured to display an image.

The touch driving chip may be mounted on the peripheral region of the touch panel.

The touch driving chip may be mounted on the peripheral region of the touch panel in a chip-on-glass structure.

The touch panel may include a plurality of touch electrodes configured to sense the touch event, a plurality of signal lines electrically connecting the touch electrodes and the touch driving chip and a transmitting line electrically connecting between the touch driving chips.

According to embodiments of the present invention, touch driving chips may be disposed on the touch panel. Advantageously, the module structures of a touch panel and a touch panel driver may be substantially simple, and the associated manufacturing cost may be substantially minimized.

### BRIEF DESCRIPTION OF THE DRAWINGS

FIG. 1 is a block diagram illustrating a touch display apparatus according to an embodiment of the present invention.

FIG. 2 is a plan view illustrating a touch panel, a touch panel driver, and a host of FIG. 1.

FIG. 3 is a plan view illustrating a portion of the touch panel of FIG. 2.

FIG. 4 is a partial plan view illustrating elements in a portion of the touch panel of FIG. 3.

FIG. 5 is a cross-sectional view illustrating the touch panel cut along a line I-I′ indicated in FIG. 4.

FIGS. 6A to 6F are cross-sectional views illustrating a method for manufacturing the touch panel of one or more of FIGS. 1 to 3.

FIGS. 7A to 7E are partial plan views illustrating the method for manufacturing the touch panel of one or more of FIGS. 1 to 3.

FIG. 8 is a plan view illustrating a touch panel, a touch panel driver, and a host according to an embodiment of the present invention.

FIG. 9 is a plan view illustrating a touch panel, a touch panel driver, and a host according to an embodiment of the present invention.

### DETAILED DESCRIPTION OF THE INVENTION

Hereinafter, embodiments of the present invention will be described in detail with reference to the accompanying drawings. In the description, the word “connect” may mean “electrically connect”; the word “insulate” may mean “electrically insulate”.

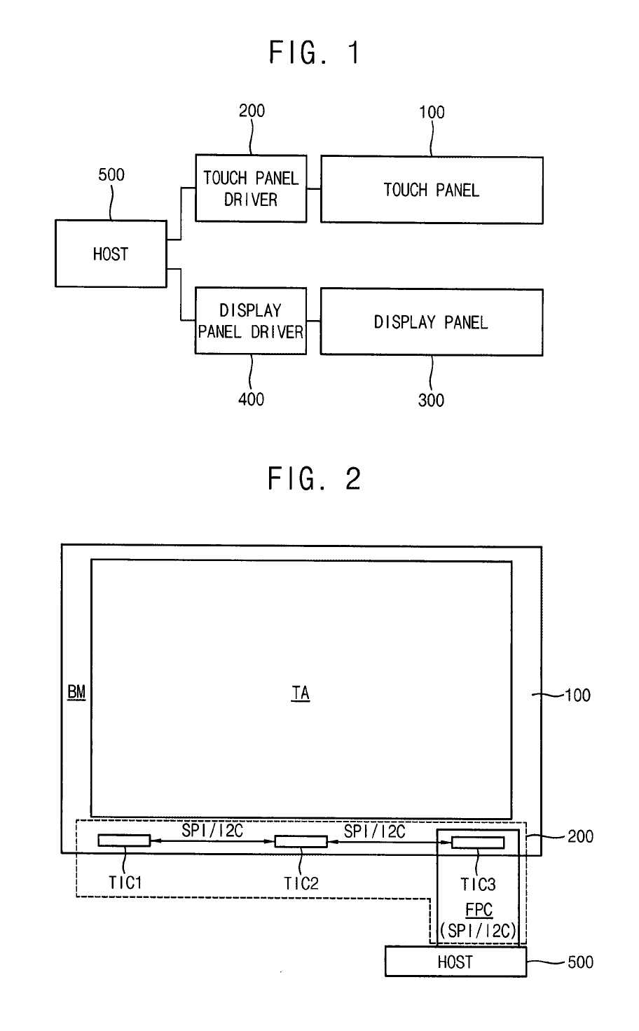

FIG. 1 is a block diagram illustrating a touch display apparatus according to an embodiment of the present invention.

Referring to FIG. 1, the touch display apparatus includes a touch unit, a display unit, and a host 500. The touch unit includes a touch panel 100 and a touch panel driver 200. The display unit includes a display panel 300 and a display panel driver 400.

The touch panel 100 may sense a touch event (which may include one or more touches) provided by a touch providing means, such as a stylus pen or at least a finger of a user of the touch display apparatus. For example, the touch panel 100 may be/include at least one of a capacitive type touch panel, a resistive type touch panel, and an optical type touch panel.

The touch panel driver 200 is connected to the touch panel 100. The touch panel driver 200 may provide a driving signal to control the touch panel 100. The touch panel driver 200 may receive a sense signal from the touch panel 100. The touch panel driver 200 may determine touch coordinate information (or coordinate data) associated with the location(s) of the touch event.

The touch panel driver 200 may output the touch coordinate information to the host 500.

The display panel 300 may display an image. The display panel 300 includes a plurality of gate lines, a plurality of data lines, and a plurality of pixels connected to the gate lines and the data lines. The gate lines may extend in a first direction, and the data lines may extend in a second direction crossing the first direction.

For example, the display panel 300 may be/include at least one of a liquid crystal display (LCD) panel, an organic light emitting diode (OLED) display panel, a plasma display panel (PDP), and a light emitting diode (LED) display panel.

A pixel of the pixels may include a switching element, a liquid crystal capacitor, and a storage capacitor. The liquid crystal capacitor and the storage capacitor are electrically connected to the switching element. The pixels may be disposed in a matrix (or rectangular array) form.

The display panel driver 400 is connected to the display panel 300 to control the display panel 300. The display panel driver 400 may receive the touch coordinate information and may enable the display panel 300 to display a suitable image based on the touch coordinate information.

The display panel driver 400 includes a timing controller, a gate driver, a gamma reference voltage generator, and a data driver.

The timing controller may receive input image data and an input control signal from the host 500. The input image data may include red image data, green image data, and blue image data. The input control signal may include a master clock signal, a data enable signal, a vertical synchronizing signal, and a horizontal synchronizing signal.

The timing controller may generate a first control signal, a second control signal, a third control signal, and a data signal based on the input image data and the input control signal.

The timing controller may generate the first control signal based on the input control signal and may output the first control signal to the gate driver for controlling the gate driver.

The timing controller may generate the second control signal based on the input control signal and may output the second control signal to the data driver for controlling the data driver.

The timing controller may generate the data signal based on the input image data. The timing controller may output the data signal to the data driver.

The timing controller may generate the third control signal based on the input control signal and may output the third control signal to the gamma reference voltage generator for controlling the gamma reference voltage generator.

The gate driver may generate gate signals in response to the first control signal received from the timing controller. The gate driver may sequentially output the gate signals to the gate lines for controlling the pixels.

The gamma reference voltage generator may generate a gamma reference voltage in response to the third control signal received from the timing controller. The gamma reference voltage generator may provide the gamma reference voltage to the data driver. The gamma reference voltage may have a value corresponding to a level of the data signal.

The data driver may receive the second control signal and the data signal from the timing controller and may receive the gamma reference voltages from the gamma reference voltage generator. The data driver may use the gamma reference voltages to convert the data signal into analog data voltages. The data driver may output the data voltages to the data lines for controlling the pixels.

The host 500 is connected to the touch panel driver 200 and the display panel driver 400. The host 500 may control operations of the touch panel driver 200 and the display panel driver 400. The host 500 may provide input signals to the touch panel driver 200 and the display panel driver 400. For example, the host 500 may include a setting/configuration board (set board).

FIG. 2 is a plan view illustrating the touch panel 100, the touch panel driver 200, and the host 500 of FIG. 1.

Referring to FIGS. 1 and 2, the touch panel 100 includes an active region TA in which a touch event is to be sensed and includes a peripheral region that surrounds the active region TA. A light blocking layer BM may be disposed in the peripheral region. The light blocking layer BM may be black.

The touch panel driver 200 includes a plurality of touch driving chips TIC1, TIC2, and TIC3 and includes a flexible printed circuit board FPC that connects at least one of the touch driving chips TIC1, TIC2, and TIC3 to the host 500.

The first touch driving chip TIC1, the second touch driving chip TIC2, and the third touch driving chip TIC3 may be disposed in the peripheral region and may overlap the light blocking layer BM. The first touch driving chip TIC1 may sense a touch event (e.g., one or more touches) in a left portion of the active region TA, which corresponds to the first touch driving chip TIC1. The second touch driving chip TIC2 may sense a touch event in a central portion of the active region TA, which corresponds to the second touch driving chip TIC2. The third touch driving chip TIC3 may sense a touch event in a right portion of the active region TA, which corresponds to the third touch driving chip TIC3.

The third touch driving chip TIC3 may be connected to (and may overlap) the flexible printed circuit board FPC 200. The third touch driving chip TIC3 may be a master driving chip. The touch driving chips TIC1 and TIC2 may be slave driving chips. The master driving chip TIC3 may generate touch coordinate information based on at least one of touch information generated at the master driving chip TIC3, touch information received from the first slave touch driving chip TIC I, and touch information received from the second slave touch driving chip TIC2. The master driving chip TIC3 may output the touch coordinate information to the host 500 through the flexible printed circuit board FPC.

The touch driving chips TIC1, TIC2, and TIC3 may be mounted on the peripheral region of the touch panel 100 using, for example, a chip-on-glass method.

In an embodiment, the touch driving chips TIC1, TIC2, and TIC3 may be disposed along a first side of the touch panel 100. The flexible printed circuit board FPC 200 may extend from the first side of the touch panel 100 and beyond the touch panel 100 to be connected to the host 500.

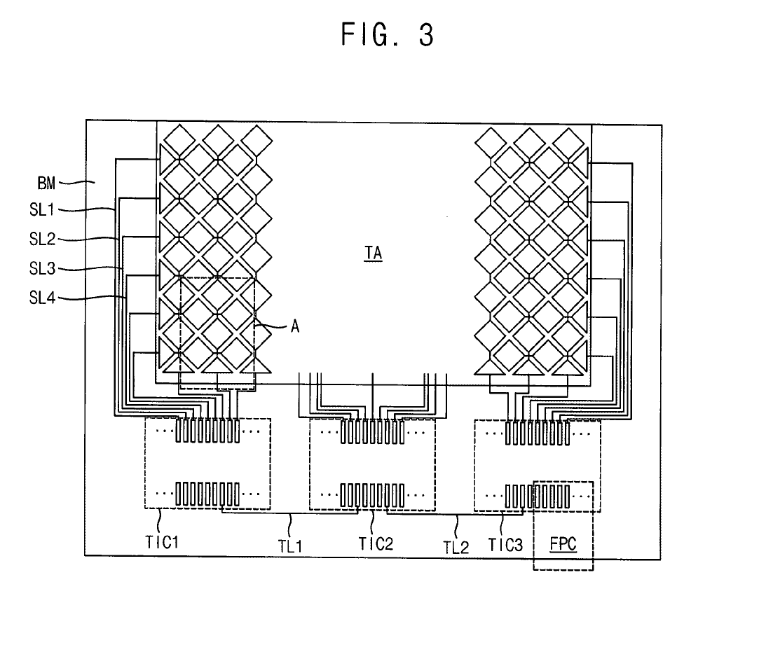

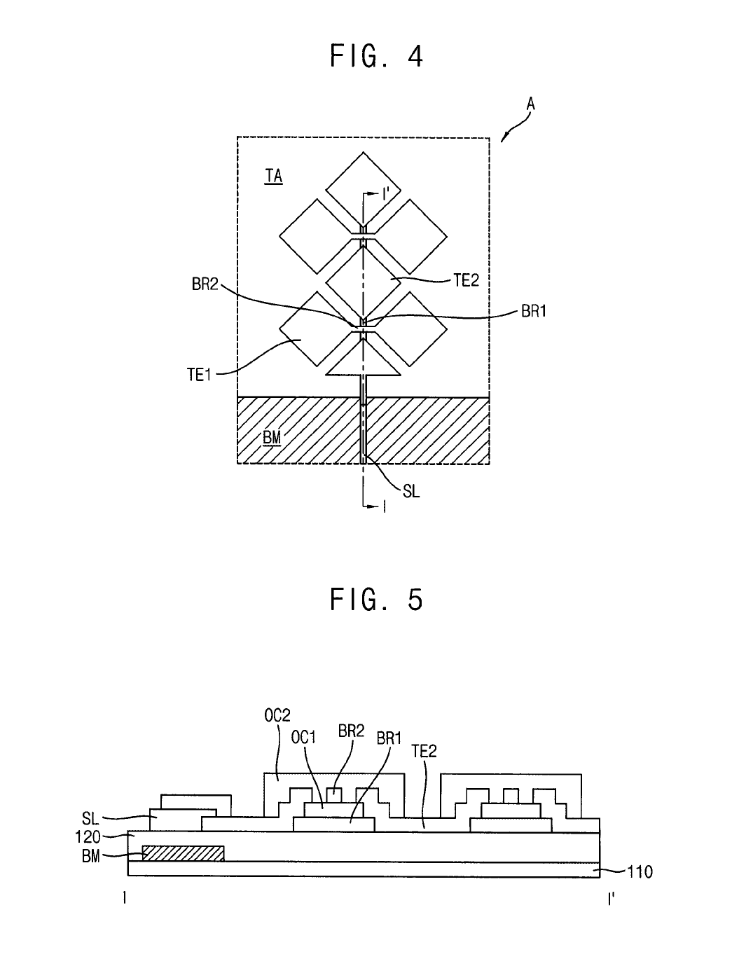

FIG. 3 is a plan view illustrating a portion of the touch panel 100 of FIG. 2. FIG. 4 is a partial plan view illustrating elements in a portion A of the touch panel 100 of FIG. 3.

Referring to FIGS. 1 to 4, the touch panel 100 includes a plurality of touch electrodes, such as first-type touch electrodes TE1 and second-type touch electrodes TE2, and includes a plurality of signal lines SL, such as SL1, SL2, SL3, and SL4, connecting the touch electrodes TE1 and TE2 to the touch driving chip TIC1, TIC2, and TIC3. The touch electrodes TE1 and TE2 may be substantially disposed in the active region TA. The signal lines SL may be substantially disposed in the peripheral region and may substantially overlap the light blocking layer BM. The signal lines SL may be connected to the touch driving chip TIC1, TIC2, and TIC3 through a plurality of signal pads.

The touch electrodes TE I and TE2 may include a plurality of transmitter/transceiver electrodes and a plurality of receiver electrodes. For example, a first-type touch electrode TE1 may be a receiver electrode for receiving a driving signal. For example, a second-type touch electrode TE2 may be a transmitter/transceiver electrode for outputting a sense signal. Adjacent (e.g., immediately neighboring) first-type touch electrodes TE1 may be connected to each other through a second-type bridge BR2 extending in a first direction (e.g., a horizontal direction). Adjacent (e.g., immediately neighboring) second-type touch electrodes TE2 may be connected to each other through a first-type bridge BR1 extending in a second direction (a vertical direction) different from the first direction.

The signal lines may include a plurality of driving lines connecting the plurality of receiving electrodes TE1 to the touch driving chip TIC1 and may include a plurality of sensing lines connecting the plurality of transmitting/transceiving electrodes TE2 to the touch driving chip TIC1.

In an embodiment, each of the first touch driving chip TIC1 and the third touch driving chip TIC3 may be connected to both of a set of driving lines and a set of sensing lines. The second driving chip TIC2 may be connected a set of sensing lines without being electrically connected to driving lines.

In an embodiment, the touch electrodes TE1 and TE2 may have rhombus shapes. In an embodiment, the touch electrodes TE1 and TE2 may have one or more of other shapes.

The touch electrodes TE1 and TE2 may operate in a mutual capacitance configuration in an embodiment. In an embodiment, the touch panel 100 may operate in a self-capacitance configuration (and/or structure).

The touch panel 100 may be a capacitive type touch panel in an embodiment. In an embodiment, the touch panel may be of another type.

The touch panel 100 further includes transmitting lines, e.g., TL1 and TL2, connecting the touch driving chips TIC1, TIC2, and TIC3. The first touch driving chip TIC1 and the second touch driving chip TIC2 may be connected to each other through a first transmitting line TL1. The second touch driving chip TIC2 and the third touch driving chip TIC3 may be connected to each other through a second transmitting line TL2.

In an embodiment, the third driving chip is a master driving chip, each of the first touch driving chip TIC1 and the second driving chip TIC2 may be electrically connected to the third touch driving chip TIC3 through a transmitting line and not through an intervening driving chip.

The transmitting lines TL1 and TL2 may be disposed in the peripheral region and may overlap the light blocking layer BM. The plurality of touch driving chips may communicate with each other through the transmitting line in a serial peripheral interface (SPI) configuration (and/or structure) or an inter-integrated circuit (I2C) configuration (and/or structure).

The SPI configuration (and/or structure) may include a synchronous serial communication configuration (and/or structure). In the SPI configuration (and/or structure), each of the transmitting lines TL1 and TL2 may include a first sub-line, a second sub-line, and a third sub-line. The first sub-line is a Master Out, Slave In (MOSI) line. The second sub-line is a Master In, Slave Out (MISO) line. The third sub-line is a Serial Clock (SLCK) line. Using the first to third sub-lines, a full duplex communication may be operated.

The I2C configuration (and/or structure) may include a synchronous or asynchronous serial communication configuration (and/or structure). In the I2C configuration, each of the transmitting lines TL1 and TL2 may include a first sub-line and second sub-line. The first sub line is a Serial Data (SDA) line. The second sub line is a Serial Clock (SCL) line. Using the first and second sub-lines, a half duplex communication may be operated.

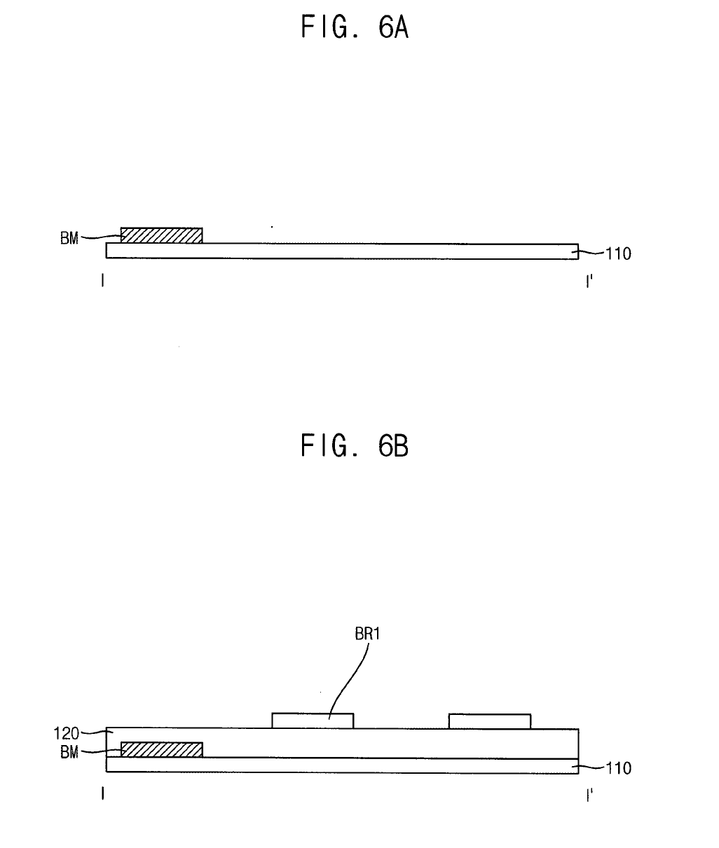

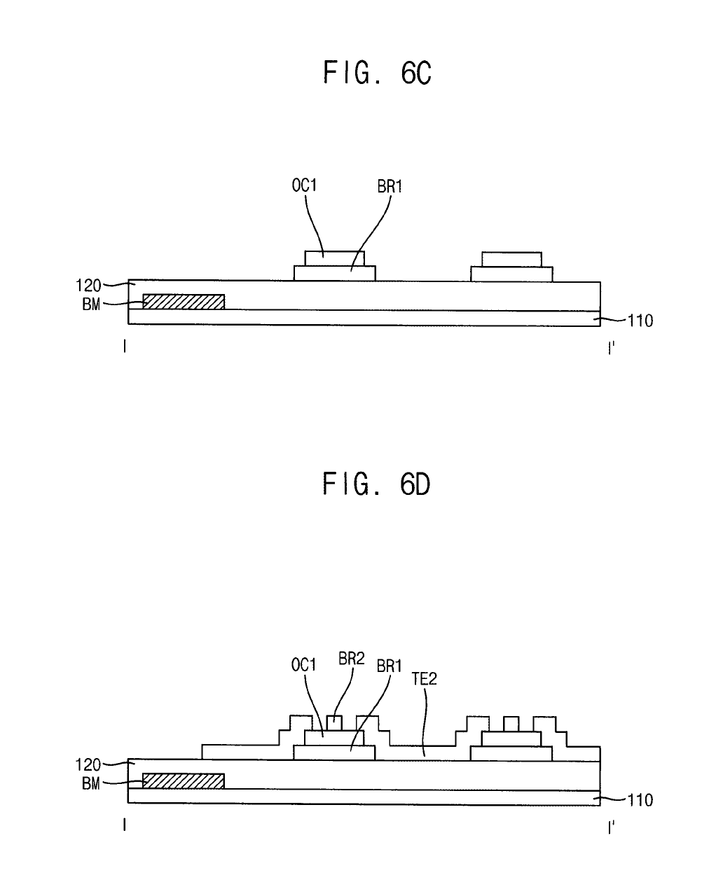

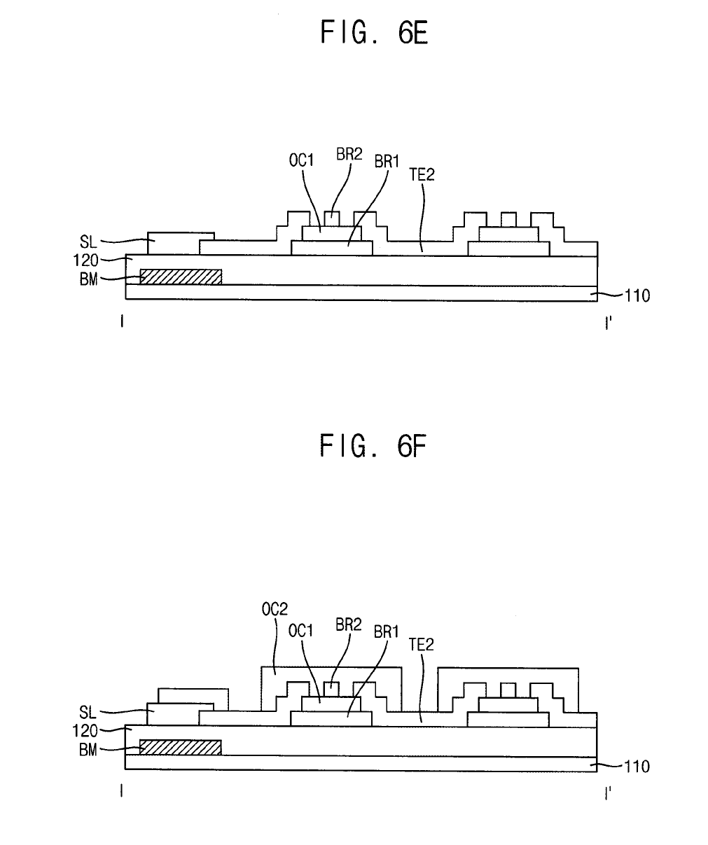

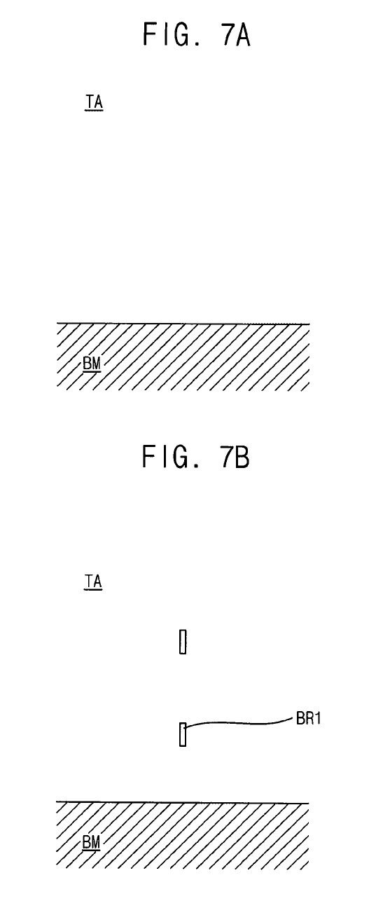

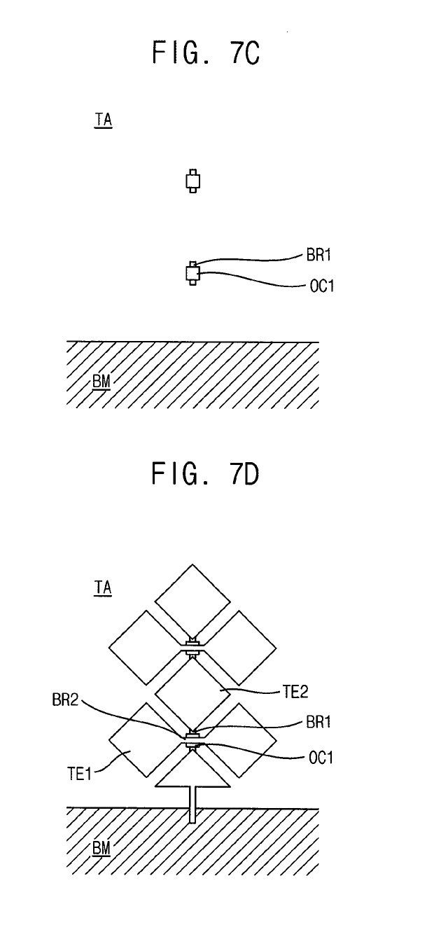

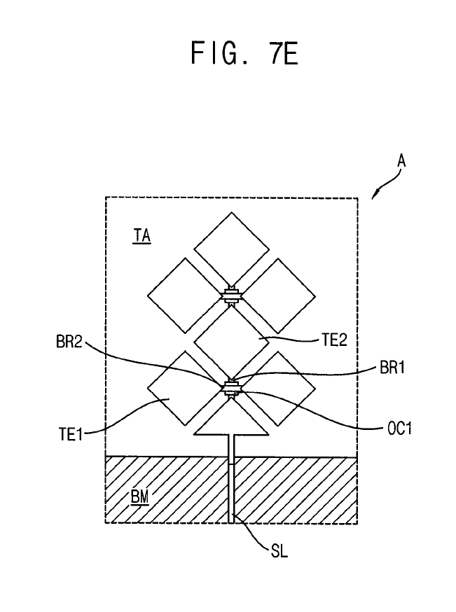

FIG. 5 is a cross-sectional view illustrating the touch panel 100 cut along a line I-I′ indicated in FIG. 4. FIGS. 6A to 6F are cross-sectional views illustrating a method for manufacturing the touch panel 100 of one or more of FIGS. 1 to 3. FIGS. 7A to 7E are partial plan views (associated with the portion A indicated in FIG. 3) illustrating the method for manufacturing the touch panel 100 of one or more of FIGS. 1 to 3.

Referring to FIGS. 6A and 7A, the light blocking layer BM is formed on a first surface (e.g., a front surface) of a base substrate 110 of the touch panel 100. The light blocking layer BM may be formed using a first mask. The light blocking layer BM may include a material which blocks light. The peripheral region and the active region TA may be defined by the light blocking layer BM. In an embodiment, elements of a display panel may be disposed on a second surface (e.g., a rear surface overlapping the front surface) of the base substrate 110, such that the base substrate 110 may also be a display substrate of the touch display apparatus. In an embodiment, a display substrate of the touch display apparatus may overlap (and may contact) the base substrate 110.

Referring to FIGS. 6B and 7B, an index matching layer 120 is formed on the base substrate 110 and the light blocking layer BM. The index matching layer 120 may adjust a refractive index to prevent a pattern, e.g., a pattern associated with indium tin oxide (ITO) patterning, from being visible to a user of the touch display apparatus. The index matching layer 120 may substantially cover an entire surface of the base substrate 110, including the active region TA and the peripheral region. An upper surface of the index matching layer 120 may be substantially flat.

The first-type bridges BR1 may be formed on the index matching layer 120. The first-type bridge BR1 may be formed using a second mask. The first-type bridges BR1 may include a transparent conductive material. For example, the first-type bridges BR1 may include ITO. The first-type bridges BR1 may extend in a vertical direction in a plan view of the touch panel and/or the touch display apparatus.

Referring to FIGS. 6C and 7C, portions of a first insulating layer OC1 may be formed on the first bridges BR1. The first insulating layer OC I may be formed using a third mask. The first insulating layer OC 1 includes an insulating material. The first insulating layer OC1 electrically insulates the first-type bridges BR1 from the subsequently formed second-type bridge BR2. The first insulating layer OC I may expose a first end portion (e.g., an upper portion) and/or a second end portion (e.g., a lower portion) of each first-type bridge BR1. In an embodiment, the first insulating layer OC1 may substantially cover an entire surface of the base substrate 110.

Referring to FIGS. 6D and 7D, a transparent conductive pattern is formed on the index matching layer 120, the first bridge BR1, and the first insulating layer OC1. The transparent conductive pattern may be formed using a fourth mask. The transparent conductive pattern may include the first-type touch electrodes TE1, the second-type touch electrodes TE2, and the second-type bridges BR2. The first-type touch electrodes TE1, the second-type touch electrodes TE2, and the second-type bridges BR2 may be simultaneously formed. The first-type touch electrodes TE1, the second-type touch electrodes TE2, and the second-type bridges BR2 may include substantially the same material. For example, the first-type touch electrodes TE1, the second-type touch electrodes TE2, and the second-type bridges BR2 may all include ITO.

The second-type bridges BR2 may extend in a horizontal direction in a plan view of the touch panel and/or the touch display apparatus. Two first-type touch electrodes TE1 may be respectively formed at a two opposite sides of a second-type bridge BR2 and maybe electrically connected to each other through the second-type bridge BR2. Two second-type touch electrodes TE2 may respectively overlap, contact, and/or connect to the first end portion (e.g., the upper portion) and the second end portion (e.g., the lower portion) of a first-type bridge BR1 which are exposed by the first insulating layer OC1.

The first insulating layer OC1 may insulate the second-type bridges BR2 from the first-type bridges BR1.

An extended portion (or extension) of a second-type touch electrode TE2 may extend to overlap a portion of the light blocking layer BM.

Referring to FIGS. 6E and 7E, a signal line SL may be formed on (and may directly contact) both the index matching layer 120 and the extended portion of a second-type touch electrode TE2. The signal line SL may be substantially covered (or overlapped) by the light blocking layer BM. The signal line SL may partially overlap the extended portion of the second-type touch electrode TE2 and may be connected to the second-type touch electrode TE2.

Referring to FIG. 3, in an embodiment, the transmitting lines TL1 and TL2 may be formed (on the index matching layer 120) simultaneously with the signal lines SL. The signal lines SL and the transmitting lines TL1 and TL2 may include substantially the same material. For example, the signal lines SL and the transmitting lines TL1 and TL2 may include a metal. The signal lines SL and the transmitting lines TL1 and TL2 may be formed using a fifth mask.

Transmitting lines between touch driving chips, such as the transmitting lines TL1 and TL2 may be formed directly on the touch panel 100. Advantageously, a module structure of a touch display apparatus that includes a touch panel according to an embodiment of the invention may be substantially less complicated than a module structure of a conventional touch display apparatus, which may include transmitting lines formed on a printed circuit board that is separate from the touch panel. In an embodiment of the invention, the transmitting lines TL1 and TL2 are formed simultaneously with the signal lines SL. Advantageously, no additional process may be required for forming the transmitting lines TL1 and TL2, such that manufacturing cost for forming the transmitting lines TL1 and TL2 may be minimized.

Referring to FIG. 6F, a second insulating layer OC2 is formed on the second-type touch electrodes TE2, the first insulting layer OC1, and the second-type bridges BR2. The second insulating layer OC2 may be formed using a sixth mask. The second insulating layer OC2 includes an insulating material. In an embodiment, the second insulating layer OC2 may substantially cover an entire surface of the base substrate 110.

According to embodiments of the invention, the plurality of touch driving chips TIC1, TIC2, and TIC3 are directly mounted on the touch panel 100, and the touch driving chips TIC1, TIC2, and TIC3 may communicate with one another so that touch coordinate information may be outputted to the host 500 using a single flexible printed circuit board FPC. Thus, module structures of the touch panel 100 and the touch panel driver 200 may be substantially simple, and the manufacturing cost associated with the touch panel 100 and the touch panel driver 200 may be substantially minimized.

In an embodiment, the transmitting lines TL1 and TL2 for enabling communication between the touch driving chips TIC1 TIC2, and TIC3 may be formed directly on the touch panel 100 and/or may be formed simultaneously with the signal lines SL. Advantageously, module structures of the touch panel 100 and the touch panel driver 200 may be substantially simple, and the manufacturing cost associated with the touch panel 100 and the touch panel driver 200 may be substantially minimized.

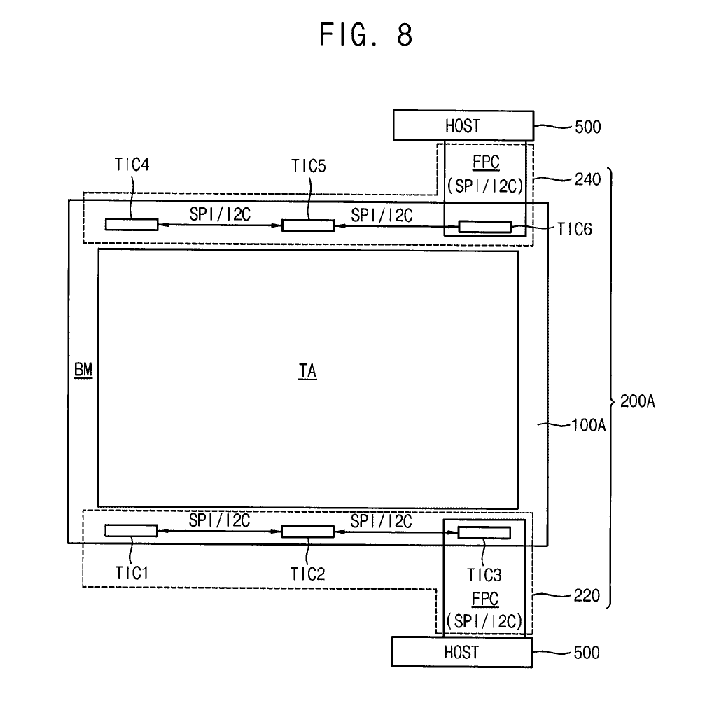

FIG. 8 is a plan view illustrating a touch panel 100A, a touch panel driver 200A, and hosts 500 according to an embodiment.

Some elements and/or structures of the touch display apparatus illustrated in FIG. 8 may be substantially identical to and/or analogous to some elements and/or structures of the touch display apparatus described with reference to one or more of FIGS. 1 to 7E. Same reference numerals may be used to refer to same or like parts, and some related description may not be repeated. Some elements illustrated in FIG. 8 may be used in place of some elements illustrated in FIG. 1.

Referring to FIGS. 1 and 8, the touch display apparatus includes a touch unit, a display unit, and a host 500 (which is represented by two boxes in FIG. 8). The touch unit includes a touch panel 100A and a touch panel driver 200A. The display unit includes a display panel 300 and a display panel driver 400.

The touch panel 100A may sense a touch event (which may include one or more touches) provided by a touch providing means, such as a stylus pen or at least a finger of a user of the touch display apparatus. For example, the touch panel 100A may be/include at least one of a capacitive type touch panel, a resistive type touch panel, and an optical type touch panel.

The touch panel driver 200A is connected to the touch panel 100A. The touch panel driver 200A may provide a driving signal to control the touch panel 100A. The touch panel driver 200A may receive a sense signal from the touch panel 100A. The touch panel driver 200A may determine touch coordinate information associated with the location(s) of the touch event.

The touch panel driver 200A may output the touch coordinate information to the host 500.

The display panel 300 may display an image. The display panel 300 includes a plurality of gate lines, a plurality of data lines, and a plurality of pixels connected to the gate lines and the data lines.

The display panel driver 400 is connected to the display panel 300 to control the display panel 300. The display panel driver 400 may receive the touch coordinate information and may enable the display panel 300 to display a suitable image based on the touch coordinate information.

The host 500 is connected to the touch panel driver 200A and the display panel driver 400. The host 500 may control operations of the touch panel driver 200A and the display panel driver 400. The host 500 may provide input signals to the touch panel driver 200A and the display panel driver 400. For example, the host 500 may be a setting/configuration board (set board).

The touch panel 100A includes an active region TA in which a touch event is to be sensed and includes a peripheral region that surrounds the active region TA. A light blocking layer BM may be disposed in the peripheral region. The light blocking layer BM may be black.

The touch panel driver 200A includes a plurality of touch driving chips TIC1, TIC2, TIC3, TIC4, TIC5, and TIC6 and includes one or more flexible printed circuit boards FPC that may connect at least one of the touch driving chips TIC1, TIC2, TIC3, TIC4, TIC5, and TIC6 to the host 500. In an embodiment, the touch panel driver 200A includes a first flexible printed circuit board 220 and a second flexible printed circuit board 240.

The first touch driving chip TIC 1, the second touch driving chip TIC2, the third touch driving chip TIC3, the fourth touch driving chip TIC4, the fifth touch driving chip TIC5, and the sixth touch driving chip TIC6 may be disposed in the peripheral region and may overlap the light blocking layer BM. The first to third touch driving chips TIC1 to TIC3 may be disposed along a first side of the touch panel 100A. The fourth to sixth touch driving chips TIC4 to TIC6 are disposed along a second side of the touch panel 100A opposite the first side of the touch panel 100A. The active area TA may be positioned between at least one of touch driving chips TIC1 to TIC3 and at least one of touch driving chips TIC4 to TIC6 in a plan view of the touch panel 100A and/or the touch display apparatus.

The first touch driving chip TIC1 may sense a touch event in a left and lower portion of the active region TA, which corresponds to the first touch driving chip TIC1. The second touch driving chip TIC2 may sense a touch event in a central and lower portion of the active region TA, which corresponds to the second touch driving chip TIC2. The third touch driving chip TIC3 may sense a touch event in a right and lower portion of the active region TA, which corresponds to the third touch driving chip TIC3. The fourth touch driving chip TIC4 may sense a touch event in a left and upper portion of the active region TA, which corresponds to the fourth touch driving chip TIC4. The fifth touch driving chip TIC5 may sense a touch event in a central and upper portion of the active region TA, which corresponds to the fifth touch driving chip TIC5. The sixth touch driving chip TIC6 may sense a touch event in a right and upper portion of the active region TA, which corresponds to the sixth touch driving chip TIC6.

The third touch driving chip TIC3 may be connected to (and may overlap) the first flexible printed circuit board 220. The third touch driving chip TIC3 may be a first master driving chip. The first and second touch driving chips TIC1 and TIC2 may be first and second slave driving chips. The first master driving chip TIC3 may generate a set of lower touch coordinate information based on at least one of touch information generated at the first master driving chip TIC3, touch information received from the first slave driving chip TIC1, and touch information received from the second slave driving chip TIC2. The first master driving chip TIC3 may output the lower touch coordinate information to the host 500 through the first flexible printed circuit board 220.

The sixth touch driving chip TIC6 may be connected to (and may overlap) the second flexible printed circuit board 240. The sixth touch driving chip TIC6 may be a second master driving chip. The fourth and fifth touch driving chips TIC4 and TIC5 may be third and fourth slave driving chips. The second master driving chip TIC6 may generate a set of upper touch coordinate information based on at least one of touch information generated at the second master driving chip TIC6, touch information received from the third slave driving chip TIC4, and touch information received from the fourth slave driving chip TIC5. The second master driving chip TIC6 may output the upper touch coordinate information to the host 500 through the second flexible printed circuit board 240.

Although, for convenience of explanation, the host 500 is represented by two boxes in FIG. 8, the host 500 may be a single element. The first flexible printed circuit board 220 and the second flexible printed circuit board 220 may be bent toward the host 500 and commonly connected to the host 500.

The touch driving chips TIC 1 to TIC6 may be mounted on the peripheral region of the touch panel 100A and may overlap the light blocking layer BM. For example, the touch driving chips TIC1 to TIC6 may be mounted on the peripheral region of the touch panel 100A in a chip-on-glass configuration.

In an embodiment, the touch driving chips TIC 1 to TIC6 may be disposed along a first side and a second side of the touch panel 100A. The first flexible printed circuit board 220 may extend from the first side of the touch panel 100A and may extend beyond the touch panel 100A to be connected to the host 500. The second flexible printed circuit board 240 may extend from the second side of the touch panel 100A and may extend beyond the touch panel 100A to be connected to the host 500.

According to embodiments of the invention, the plurality of touch driving chips TIC1 to TIC6 are directly mounted on the touch panel 100A and the touch driving chips TIC1 to TIC6 may communicate with one another so that touch coordinate information may be outputted to the host 500 using two flexible printed circuit boards 220 and 240. Thus, module structures of the touch panel 100A and the touch panel driver 200A may be substantially simple, and the manufacturing cost associated with the touch panel 100A and the touch panel driver 200A may be substantially minimized.

In an embodiment, the transmitting lines the SPI/I2Cs illustrated in FIG. 8) for enabling communication between the touch driving chips TIC1 to TIC6 may be formed directly on the touch panel 100A and/or may be formed simultaneously with signal lines that are connected between touch electrodes and touch driving chips. Advantageously, module structures of the touch panel 100 and the touch panel driver 200 may be substantially simple, and the manufacturing cost associated with the touch panel 100A and the touch panel driver 200A may be substantially minimized.

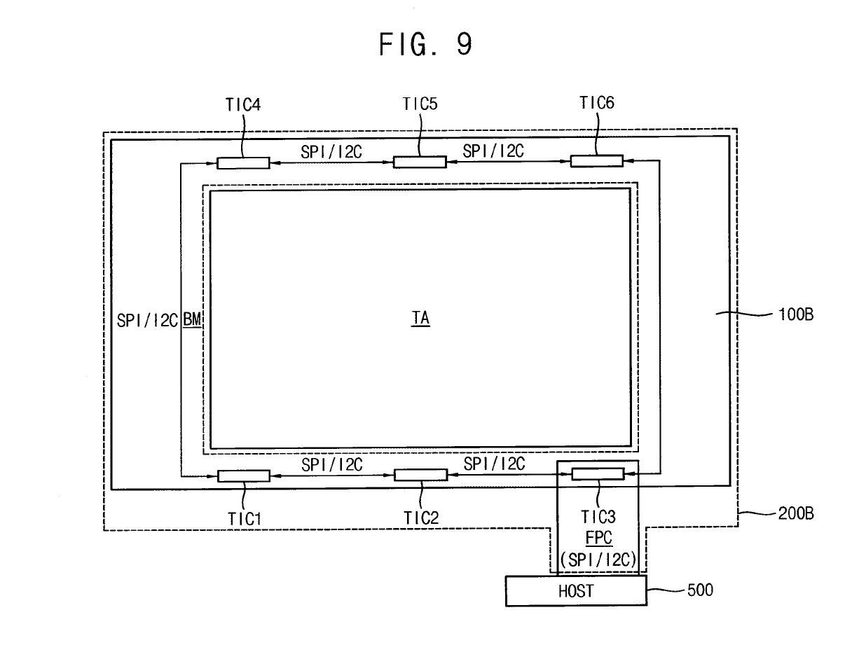

FIG. 9 is a plan view illustrating a touch panel 100B, a touch panel driver 200B, and a host 500 according to an embodiment.

Some elements and/or structures of the touch display apparatus illustrated in FIG. 9 may be substantially identical to and/or analogous to some elements and/or structures of the touch display apparatus described with reference to FIGS. 1 to 8. Same reference numerals may be used to refer to same or like parts, and some related description may not be repeated. to Some elements illustrated in FIG. 9 may be used in place of some elements illustrated in FIG. 1.

Referring to FIGS. 1 and 9, the touch display apparatus includes a touch unit, a display unit and a host 500. The touch unit includes a touch panel 100B and a touch panel driver 200B. The display unit includes a display panel 300 and a display panel driver 400.

The touch panel 100B may sense a touch event (which may include one or more touches) provided by a touch providing means, such as a stylus pen or at least a finger of a user of the touch display apparatus. For example, the touch panel 100B may be/include at least one of a capacitive type touch panel, a resistive type touch panel, and an optical type touch panel.

The touch panel driver 200B is connected to the touch panel 100B. The touch panel driver 200B may provide a driving signal to control the touch panel 100B. The touch panel driver 200B may receive a sense signal from the touch panel 100B. The touch panel driver 200B may determine touch coordinate information associated with the location(s) of the touch event.

The touch panel driver 200B may output the touch coordinate to the host 500.

The display panel 300 may display an image. The display panel 300 includes a plurality of gate lines, a plurality of data lines and a plurality of pixels connected to the gate lines and the data lines.

The display panel driver 400 is connected to the display panel 300 to control the display panel 300. The display panel driver 400 may receive the touch coordinate information and may enable the display panel 300 to display a suitable image based on the touch coordinate information.

The host 500 is connected to the touch panel driver 200B and the display panel driver 400. The host 500 may control operations of the touch panel driver 200B and the to display panel driver 400. The host 500 may provide input signals to the touch panel driver 200B and the display panel driver 400. For example, the host 500 may be a setting/configuration board (set board).

The touch panel 100B includes an active region TA in which a touch event is to be sensed and a peripheral region that surrounds the active region TA. A light blocking layer BM may be disposed in the peripheral region. The light blocking layer BM may be black.

The touch panel driver 200B includes a plurality of touch driving chips TIC1, TIC2, TIC3, TIC4, TIC5, and TIC6 and includes a flexible printed circuit board FPC that connects at least one of the touch driving chips TIC1, TIC2, TIC3, TIC4, TIC5, and TIC6 to the host 500.

The first touch driving chip TIC1, the second touch driving chip TIC2, the third touch driving chip TIC3, the fourth touch driving chip TIC4, the fifth touch driving chip TIC5, and the sixth touch driving chip TIC6 may be disposed in the peripheral region and may overlap the light blocking layer BM. The first to third touch driving chips TIC1 to TIC3 may be disposed along a first side of the touch panel 100B. The fourth to sixth touch driving chips TIC4 to TIC6 may be disposed along a second side of the touch panel 100B opposite the first side of the touch panel 100B. The active area TA may be positioned between at least one of touch driving chips TIC1 to TIC3 and at least one of touch driving chips TIC4 to TIC6 in a plan view of the touch panel 100A and/or the touch display apparatus.

The first touch driving chip TIC I may sense a touch event in a left and lower portion of the active region TA, which corresponds to the first touch driving chip TIC1. The second touch driving chip TIC2 may sense a touch event in a central and lower portion of the active region TA, which corresponds to the second touch driving chip TIC2. The third touch driving chip TIC3 may sense a touch event in a right and lower portion of the active region TA, which corresponds to the third touch driving chip TIC3. The fourth touch driving chip

TIC4 may sense a touch event in a left and upper portion of the active region TA, which corresponds to the fourth touch driving chip TIC4. The fifth touch driving chip TIC5 may sense a touch event in a central and upper portion of the active region TA, which corresponds to the fifth touch driving chip TIC5. The sixth touch driving chip TIC6 may sense a touch event in a right and upper portion of the active region TA, which corresponds to the sixth touch driving chip TIC6.

The third touch driving chip TIC3 may be connected to (and may overlap) the flexible printed circuit board FPC. The third touch driving chip TIC3 may be a master driving chip. The first, second, fourth, fifth, and sixth touch driving chips TIC1, TIC2, TIC4, TIC5, and TIC6 may be slave driving chips. The master driving chip TIC3 may generate a set of touch coordinate information based on touch information generated at the master driving chip TIC3 and/or touch information received from one or more of the slave driving chips TIC1, TIC2, TIC4, TIC5, and TIC6. The master driving chip TIC3 may output the touch coordinate information to the host 500 through the flexible printed circuit board FPC.

The touch driving chips TIC1 to TIC6 may be mounted on the peripheral region of the touch panel 100B and may overlap the light blocking layer BM. For example, the touch driving chips TIC1 to TIC6 may be mounted on the peripheral region of the touch panel 100B in a chip-on-glass configuration.

In an embodiment, the touch driving chips TIC1 to TIC6 may be disposed along a first side and a second side of the touch panel 100B. The flexible printed circuit board FPC may extend from the first side of the touch panel 100B and may extend beyond the touch panel 100B to be connected to the host 500.

According to embodiments of the invention, the plurality of touch driving chips TIC1 to TIC6 are directly mounted on the touch panel 100B, and the touch driving chips TIC1 to TIC6 may communicate with one another so that touch coordinate information may be outputted to the host 500 using a single flexible printed circuit board FPC. Thus, module structures of the touch panel 100B and the touch panel driver 200B may be substantially simple, and the manufacturing cost associated with the touch panel 100B and the touch panel driver 200B may be substantially minimized.

In an embodiment, the transmitting lines (e.g., the SPI/I2Cs illustrated in FIG. 9) for communication between the touch driving chips TIC1 to TIC6 may be formed directly on the touch panel 100B and/or may be formed simultaneously with the signal lines that are connected between touch electrodes and touch driving chips. Advantageously, module structures of the touch panel 100 and the touch panel driver 200 may be substantially simple, and the associated manufacturing cost may be substantially minimized.

According to embodiments of the present invention, module structures of touch panels and touch panel drivers may be substantially simple, and associated manufacturing cost may be substantially minimized.

The foregoing is illustrative of embodiments of the present invention and is not to be construed as limiting. Although a few embodiments of the present invention have been described, those skilled in the art will readily appreciate that many modifications are possible in the embodiments without materially departing from the novel teachings and advantages of the present invention. All such modifications are intended to be included within the scope of the present invention as defined in the claims. In the claims, means-plus-function clauses are intended to cover the structures described herein as performing the recited function and to cover not only structural equivalents but also equivalent structures.

What is claimed is:

1. A touch unit comprising:
a touch panel comprising an active region in which a touch event is sensed and a peripheral region surrounding the active region; and
a touch panel driver comprising a plurality of touch driving chips disposed in the peripheral region and a flexible printed circuit board electrically connecting the touch driving chip to a host.

2. The touch unit of claim 1, wherein the touch driving chip is mounted on the peripheral region of the touch panel.

3. The touch unit of claim 2, wherein the touch driving chip is mounted on the peripheral region of the touch panel in a chip-on-glass structure.

4. The touch unit of claim 1, wherein the touch panel comprising:
a plurality of touch electrodes configured to sense the touch event; and
a plurality of signal lines electrically connecting the touch electrodes and the touch driving chip.

5. The touch unit of claim 4, wherein the touch panel further comprises a transmitting line electrically connecting between the touch driving chips.

6. The touch unit of claim 5, wherein the signal line and the transmitting line are simultaneously formed.

7. The touch unit of claim 5, wherein the signal line and the transmitting line include substantially the same material.

8. The touch unit of claim 5, wherein the touch driving chips communicate with each other through the transmitting line in a serial peripheral interface (“SPI”) method or an inter-integrated circuit (“I2C”) method.

9. The touch unit of claim 4, wherein the touch electrodes comprise a plurality of transceiver (TX) electrodes and a plurality of receiver (RX) electrodes,
the signal lines comprise a plurality of driving lines electrically connecting the TX electrodes to the touch driving chip and a plurality of sensing lines electrically connecting the RX electrodes to the touch driving chip.

10. The touch unit of claim 9, wherein the touch panel further comprises a first bridge electrically connecting the adjacent RX electrodes and a second bridge electrically connecting the adjacent TX electrodes.

11. The touch unit of claim 10, wherein the touch panel further comprises an insulating layer disposed between the first bridge and the second bridge.

12. The touch unit of claim 10, wherein the second bridge, the RX electrode and the TX electrode are simultaneously formed.

13. The touch unit of claim 1, wherein the touch driving chips are disposed along a first side of the touch panel, and
the flexible printed circuit board extends from the first side of the touch panel to out of the touch panel.

14. The touch unit of claim 1, wherein the touch driving chips are disposed along a first side and a second side of the touch panel, and
the touch panel driver comprises a first flexible printed circuit board extending from the first side of the touch panel to out of the touch panel and a second flexible printed circuit board extending from the second side of the touch panel to out of the touch panel.

15. The touch unit of claim 1, wherein the touch driving chips are disposed along a first side and a second side of the touch panel, and
the flexible printed circuit board extends from the first side of the touch panel to out of the touch panel.

16. A touch display apparatus comprising:
a touch unit comprising:
a touch panel comprising an active region in which a touch event is sensed and a peripheral region surrounding the active region; and
a touch panel driver comprising a plurality of touch driving chips disposed in the peripheral region and a flexible printed circuit board electrically connecting the touch driving chip to a host; and
a display panel disposed under the touch panel and configured to display an image.

17. The touch display apparatus of claim 16, wherein the touch driving chip is mounted on the peripheral region of the touch panel.

18. The touch display apparatus of claim 17, wherein the touch driving chip is mounted on the peripheral region of the touch panel in a chip-on-glass structure.

19. The touch display apparatus of claim 16, wherein the touch panel comprising:
a plurality of touch electrodes configured to sense the touch event;
a plurality of signal lines electrically connecting the touch electrodes and the touch driving chip; and
a transmitting line connecting between the touch driving chips.

20. A touch unit comprising:
a substrate that includes a first region and a second region adjacent to the first region;
a first touch electrode configured to receive a touch event and overlapping the first region in an overlapping direction that is perpendicular to a surface of the substrate;
a first touch driving chip electrically connected to the first touch electrode and overlapping the second region in the overlapping direction; and
a first printed circuit board electrically connected to the first touch driving chip.
